(19) United States
(12) Patent Application Publication
(10) Pub. No.: US 2026/0333209 A1
(43) Pub. Date: Oct. 22, 2026

(54) SELECTING AN ASSISTING DEVICE

(71) Applicant: QUALCOMM Incorporated, San Diego, CA (US)

(72) Inventors: Tommy AZZINO, Jersey City, NJ (US); Navid ABEDINI, Basking Ridge, NJ (US); Junyi LI, Greentown, PA (US); Wanshi CHEN, San Diego, CA (US)

(21) Appl. No.: 19/182,496

(22) Filed: Apr. 17, 2025

(51) Int. Cl. H04W 48/20; H04W 48/08

(52) U.S. Cl. CPC H04W 48/20; H04W 48/08

(57) ABSTRACT

This disclosure provides methods, components, devices and systems for selecting an assisting device. For example, an assisting user equipment (UE) for a group of cooperating UEs may be selected based on prediction techniques. For example, a group of cooperating UEs may select an assisting UE based on temporal predictions, such as predictions of metrics used to select the assisting UE. The group of cooperating UEs may communicate, for example, link quality predictions, traffic predictions, mobility predictions, or UE consumption predictions, and an assisting UE may be selected from the group of cooperating UEs based on the predictions. In some examples, a cooperating UE may determine a single metric or score associated with the cooperating UE operating as the assisting UE.

### TECHNICAL FIELD

This disclosure relates generally to wireless communication, and more specifically to systems, devices, methods, and techniques associated with selecting an assisting device.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a device is described. The method may include receiving, from one or more UEs of a set of multiple cooperating UEs, parameter information for selection of an assisting UE from the set of multiple cooperating UEs to communicate with a network entity on behalf of the set of multiple cooperating UEs, where the parameter information is based on one or more predictions associated with the one or more UEs operating as the assisting UE and transmitting, to the one or more UEs, selection information including an indication of a first UE selected from the set of multiple cooperating UEs to operate as the assisting UE based on the parameter information.

A device for wireless communications is described. The device may include a processing system that includes processor circuitry and memory circuitry that stores code. The processing system may be configured to cause the device to receive, from one or more UEs of a set of multiple cooperating UEs, parameter information for selection of an assisting UE from the set of multiple cooperating UEs to communicate with a network entity on behalf of the set of multiple cooperating UEs, where the parameter information is based on one or more predictions associated with the one or more UEs operating as the assisting UE and transmit, to the one or more UEs, selection information including an indication of a first UE selected from the set of multiple cooperating UEs to operate as the assisting UE based on the parameter information.

Another device for wireless communications is described. The device may include means for receiving, from one or more UEs of a set of multiple cooperating UEs, parameter information for selection of an assisting UE from the set of multiple cooperating UEs to communicate with a network entity on behalf of the set of multiple cooperating UEs, where the parameter information is based on one or more predictions associated with the one or more UEs operating as the assisting UE and means for transmitting, to the one or more UEs, selection information including an indication of a first UE selected from the set of multiple cooperating UEs to operate as the assisting UE based on the parameter information.

A non-transitory computer-readable medium storing code for wireless communications is described. The code may include instructions executable by one or more processors to receive, from one or more UEs of a set of multiple cooperating UEs, parameter information for selection of an assisting UE from the set of multiple cooperating UEs to communicate with a network entity on behalf of the set of multiple cooperating UEs, where the parameter information is based on one or more predictions associated with the one or more UEs operating as the assisting UE and transmit, to the one or more UEs, selection information including an indication of a first UE selected from the set of multiple cooperating UEs to operate as the assisting UE based on the parameter information.

Some examples of the method, devices, and non-transitory computer-readable medium described herein may further include operations, features, means, or instructions for determining, for each of the set of multiple cooperating UEs, a metric based on respective parameter information of the set of multiple cooperating UEs and selecting the first UE from the set of multiple cooperating UEs to operate as the assisting UE based on a first metric for the first UE having a highest value among the set of multiple cooperating UEs.

In some examples of the method, devices, and non-transitory computer-readable medium described herein, the configuration information includes a duration associated with the one or more predictions, one or more thresholds associated with the one or more predictions, a quantity of prediction determinations associated with the duration, or any combination thereof.

In some examples of the method, devices, and non-transitory computer-readable medium described herein, the one or more predictions includes a link quality prediction, a traffic prediction, a mobility prediction, a battery consumption prediction, or any combination thereof.

A method for wireless communications by a first UE is described. The method may include transmitting, to a coordinating device, parameter information for selection of an assisting UE from a set of multiple cooperating UEs to communicate with a network entity on behalf of the set of multiple cooperating UEs where the parameter information is based on one or more predictions associated with the first UE operating as the assisting UE and receiving, from the coordinating device, selection information including an indication of a second UE selected from the set of multiple cooperating UEs to operate as the assisting UE based on the parameter information.

A first UE for wireless communications is described. The first UE may include a processing system that includes processor circuitry and memory circuitry that stores code. The processing system may be configured to cause the first UE to transmit, to a coordinating device, parameter information for selection of an assisting UE from a set of multiple cooperating UEs to communicate with a network entity on behalf of the set of multiple cooperating UEs where the parameter information is based on one or more predictions associated with the first UE operating as the assisting UE and receive, from the coordinating device, selection information including an indication of a second UE selected from the set of multiple cooperating UEs to operate as the assisting UE based on the parameter information.

Another first UE for wireless communications is described. The first UE may include means for transmitting, to a coordinating device, parameter information for selection of an assisting UE from a set of multiple cooperating UEs to communicate with a network entity on behalf of the set of multiple cooperating UEs where the parameter information is based on one or more predictions associated with the first UE operating as the assisting UE and means for receiving, from the coordinating device, selection information including an indication of a second UE selected from the set of multiple cooperating UEs to operate as the assisting UE based on the parameter information.

A non-transitory computer-readable medium storing code for wireless communications is described. The code may include instructions executable by one or more processors to transmit, to a coordinating device, parameter information for selection of an assisting UE from a set of multiple cooperating UEs to communicate with a network entity on behalf of the set of multiple cooperating UEs where the parameter information is based on one or more predictions associated with the first UE operating as the assisting UE and receive, from the coordinating device, selection information including an indication of a second UE selected from the set of multiple cooperating UEs to operate as the assisting UE based on the parameter information.

### BRIEF DESCRIPTION OF THE DRAWINGS

FIG. 1 shows an example of a wireless communication system.

FIG. 2 shows an example of a signaling diagram that supports selecting an assisting device.

FIG. 3 shows an example of a process flow that supports selecting an assisting device.

FIG. 4 shows a block diagram of a processing system that supports selecting an assisting device.

FIG. 5 shows a diagram of a system including a device that supports selecting an assisting device.

FIG. 6 shows a block diagram of a processing system that supports selecting an assisting device.

FIG. 7 shows a diagram of a system including a device that supports selecting an assisting device.

FIGS. 8 and 9 show flowcharts illustrating methods that support selecting an assisting device.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a group of user equipment (UE) may cooperate to perform different tasks, such as cell search and selection, system information acquisition, paging monitoring, or the like. UE cooperation may reduce workload for any individual UE and improve overall performance for each of the cooperating UEs. For example, the group of cooperating UEs may elect a delegate or assisting UE which performs operations with the network (e.g., via a network entity) and shares results or information from the operations with the assisted UEs. An assisting UE may be selected through local signaling between cooperating UEs or in a centralized manner, such as by being selected by the network or a separate entity. Some criteria for selecting the assisting UE may include, for example, UE battery level, measurements of radio conditions, Radio Resource Control (RRC) connection status, and UE-supported features. In some cases, different criteria may be used to select the assisting UE for different use cases. In a wireless communications system, metrics used as criteria for selecting the assisting UE may change over time. For example, one UE of the cooperating UEs may experience changing radio conditions or may move away from the group of cooperating UEs over time. If, for example, conditions change such that a UE currently selected to operate as an assisting UE is no longer suitable to operate as the assisting UE, the group of cooperating UEs may select a new assisting UE. However, frequent selection of a new assisting UE may result in increased overhead for the cooperating UEs and higher power consumption.

Aspects of the subject matter described in this disclosure relate to selecting an assisting UE based on prediction techniques. For example, a group of cooperating UEs may select an assisting UE based on temporal predictions, such as future predictions of metrics used to select the assisting UE. The group of cooperating UEs may communicate, for example, link quality predictions, UE traffic predictions, UE mobility predictions, UE battery consumption predictions, or the like, and an assisting UE may be selected from the group of cooperating UEs based on the predictions. In some examples, a cooperating UE may determine a single metric or score associated with the cooperating UE operating as the assisting UE. For example, a cooperating UE may map measurements or predictions, or both, of at least one criterion used to select the assisting UE to a single metric associated with the cooperating UE operating as the assisting UE, and the single metrics for each of the cooperating UEs may be used to select the assisting UE. In some examples, the cooperating UEs may send measurement and/or prediction information to a coordinating device, which may collect the measurement and/or prediction information for each cooperating UE. The coordinating device may select a coordinating UE to operate as the assisting UE based on the predictions for each of the coordinating UEs and indicate the selected UE to the group of coordinating UEs. In some examples, the coordinating device may be one of the cooperating UEs. In some other examples, the coordinating device may be a network entity or an entity that is separate from the cooperating UEs and the network. Additional techniques for reselecting the assisting UE based on spatial or temporal aspects are described.

Particular aspects of the subject matter described in this disclosure can be implemented to realize one or more of the following potential advantages. In some examples, by selecting an assisting UE for a group of cooperating UEs based on predictions, the described techniques can be used to reduce overhead associated with selecting the assisting UE. For example, selecting the assisting UE for the group of cooperating UEs based on predictions may increase a reliability that the assisting UE is suitable to operate as the assisting UE for a longer period compared to selecting the assisting UE based on instantaneous measurements alone. Additionally, by reducing the signaling overhead, power consumption may be reduced for the cooperating UEs. In some examples, by using a single metric that is representative of multiple criteria (e.g., including predictions) to select the assisting UE, the described techniques can be used to reduce complexity with assisting UE selection and reduce complexity with implementing UE cooperation techniques for multiple use cases.

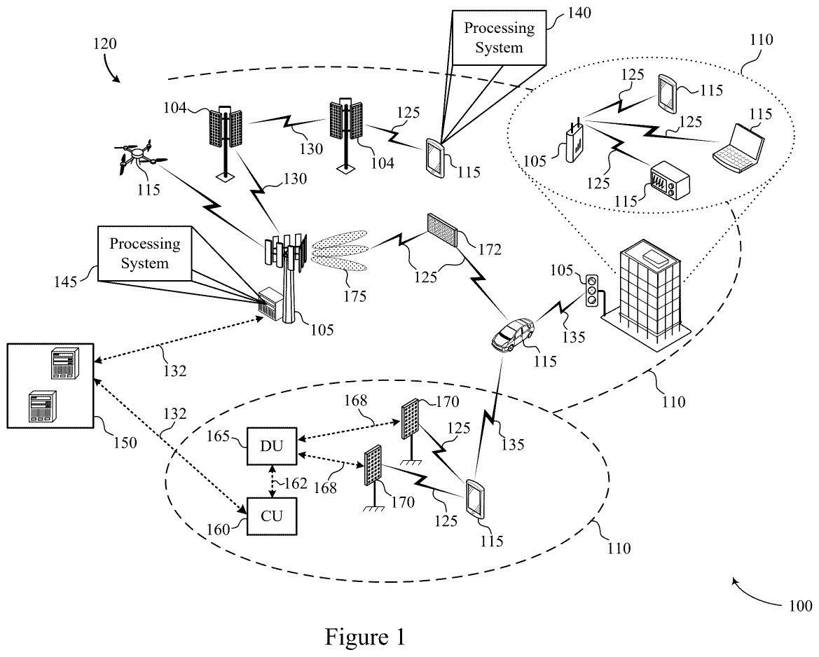

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, an RRC layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

In some wireless communication systems, a group of UEs 115 may cooperate to perform different tasks, such as cell search and selection, system information acquisition, and paging monitoring. Through UE cooperation techniques, UEs may work together to improve various aspects of network performance an efficiency. UE cooperation may enable energy-efficient operation, capacity improvements, and coverage improvements. UEs 115 may cooperate to accomplish tasks such as one or more of cell search, cell selection, cell reselection, system information acquisition, paging monitoring, or the like. UE cooperation techniques may reduce workload for any individual UE 115 and improve overall performance for each of the cooperating UEs 115.

In some cases, the group of cooperating UEs 115 may elect a delegate or assisting UE 115 which performs operations with the network (e.g., via a network entity 105) and shares results or information from the operations with the assisted UEs 115. For example, an assisting UE may obtain system information from the network entity 105 and send the system information to the cooperating UEs 115, such that the assisted UEs 115 do not need to individually obtain the system information from the network entity 105.

In some cases, an assisting UE 115 may be selected through local wireless signaling between cooperating UEs 115. Additionally, or alternatively, an assisting UE 115 may be selected in a centralized manner, such as by being selected by a network entity 105 or a separate entity, such as a third-party application. Some criteria for selecting the assisting UE 115 from a group of coordinating UEs 115 may include, for example, one or more of UE battery level, measurements of radio conditions, RRC connection status, or UE-supported features, or any combination thereof. In some cases, different criteria may be used to select the assisting UE 115 for different use cases.

In some cases, metrics used as criteria for selecting the assisting UE 115 may change over time. For example, one UE 115 of the cooperating UEs 115 may experience changing radio conditions or may move away from the group of cooperating UEs 115 over time. If, for example, conditions change such that a UE 115 currently selected to operate as an assisting UE 115 is no longer suitable to operate as the assisting UE 115, the group of cooperating UEs 115 may select a new assisting UE 115. A procedure for selecting an assisting UE 115, in either a centralized manner (e.g., determined by a network entity 105) or a distributed manner (e.g., determined by the cooperating UEs 115), may increase overhead for the cooperating UEs 115, resulting in increased power consumption and impacting overall energy efficiency gains for the cooperating UEs 115. Current techniques for selecting an assisting UE 115 may result in frequent reselection between UEs 115 as the assisting UE 115, as metrics may frequently change such that different UEs 115 are better suited to operate as the assisting UE 115 at different times. Thus, current techniques may result in frequent reselection of an assisting UE 115, resulting in increased overhead and power consumption for the cooperating UEs 115.

Additionally, there may be multiple different criteria for selecting an assisting UE 115. For example, cooperating UEs 115 may select an assisting UE 115 based on different criteria for different use cases. For example, criteria evaluated for selecting an assisting UE to improve throughput may be different from criteria evaluated to select an assisting UE to offload measurements and reduce power consumption.

Devices of the wireless communication system 100 may be configured to support one or more aspects of the described techniques for selecting an assisting device. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support reduced overhead associated with selecting an assisting UE 115 for a group of cooperating UEs 115. For example, selecting the assisting UE 115 for the group of cooperating UEs 115 based on predictions may increase a reliability that the assisting UE 115 is suitable to operate as the assisting UE 115 for a longer period compared to selecting the assisting UE 115 based on instantaneous measurements alone. Additionally, by reducing the signaling overhead, power consumption may be reduced for the cooperating UEs 115. In some examples, by using a single metric that is representative of multiple criteria (e.g., including predictions) to select the assisting UE 115, the described techniques can be used to reduce complexity with assisting UE 115 selection and reduce complexity with implementing UE cooperation techniques for multiple use cases.

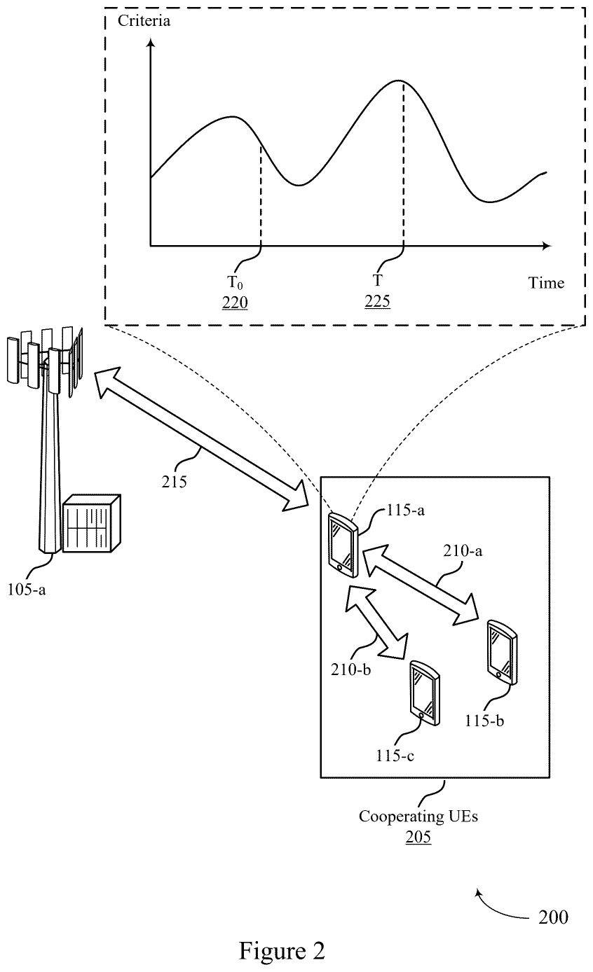

FIG. 2 shows an example of a signaling diagram 200 that supports selecting an assisting device. The signaling diagram 200 may include a network entity 105-a and a group of cooperating UEs 205. The network entity 105-a may be an example of a network entity 105 as described herein. The group of cooperating UEs 205 may include multiple UEs 115, such as a UE 115-a, a UE 115-b, and a UE 115-c, each of which may be an example of a UE 115 as described herein.

The cooperating UEs 205 may perform techniques for UE cooperation to improve energy efficiency, cell coverage, or cell capacity. In some examples, an assisting UE 115 may be selected from the cooperating UEs 205 to perform operations with a network, for example via the network entity 105-a, and share results or information from the operations with the other cooperating UEs 115. For example, the assisting UE 115 may obtain system information from the network entity 105-a and send (e.g., share or relay) the system information to the other cooperating UEs 115. In some examples, UE cooperation may be used to obtain cell search information, cell selection or reselection information, or paging information for the cooperating UEs 205. In some examples, UE cooperation may implemented such that the assisting UE 115 obtains control or data information for one or more cooperating UEs.

One of the cooperating UEs 205 may be selected as the assisting UE 115. In some examples, a process of selecting the assisting UE 115 may be referred to as electing or delegating a cooperating UE 115 to operate as the assisting UE 115. In some examples, the assisting UE 115 may be selected in a distributed manner, via local signaling between the cooperating UEs 205. For example, the cooperating UEs 205 may communicate via communication links 210 to exchange information associated with selecting an assisting UE 115. For example, one or more of the cooperating UEs may evaluate metrics for each of the cooperating UEs to determine which of the cooperating UEs is to operate as the assisting UE 115. Additionally, or alternatively, the assisting UE 115 may be selected in a centralized manner. Using a centralized manner, a network entity 105, such as the network entity 105-a, another network node, or a third-party entity (e.g., a third-party application) may select the assisting UE 115 from the cooperating UEs 205. For example, a UE 115-a may communicate with a network entity 105-a via a communication link 215 to report at least one criterion for the UE 115-a to be selected as the assisting UE 115. Additionally, or alternatively, the UE 115-a may report at least one criterion for multiple cooperating UEs to the network entity 105-a via the communication link 215.

UEs 115 of the cooperating UEs 205 which are capable of operating as the assisting UE 115 may be referred to as candidate UEs 115. In some examples, a UE 115 may determine whether the UE 115 is a candidate UE 115 or not. For example, a UE 115 may be a low power UE and may not be considered a candidate UE 115. In some examples, the cooperating UEs 205 may include one or more UEs 115 which are not candidate UEs but still participate in UE cooperation (e.g., receive information from the assisting UE 115).

In some wireless communications systems, the assisting UE 115 may be selected from the cooperating UEs 205 based on instantaneous metrics. For example, a candidate UE 115 with a current highest battery level or signal quality measurement (e.g., reference signal received power (RSRP)-to-cell measurement) may be selected as the assisting UE 115. Additionally, or alternatively, the assisting UE 115 may be selected from the cooperating UEs 205 based on, for example, RRC status or supported UE features. For example, a UE 115 operating in an RRC connected mode or an RRC idle mode may be preferred to operate as the assisting UE 115, or a non-reduced capability UE 115 may be preferred to operate as the assisting UE 115 over a reduced capability UE 115.

A procedure for selecting an assisting UE 115 may result in increased overhead for the cooperating UEs 205. For example, using either a distributed manner or a centralized manner for selecting the assisting UE 115, the cooperating UEs 205 may transmit signaling to indicate metrics for selection of the assisting UE 115 or communicate (e.g., transmit or receive) signaling that indicates the selected assisting UE 115, or both. Using instantaneous metrics may lead to scenarios where one UE 115 operates as the assisting UE 115 for a brief period before another UE 115 has better metrics to operate as the assisting UE 115. For example, the UE 115-a may be selected as the assisting UE 115 based on instantaneous metrics. After a short period of time, conditions may change at the UE 115-a or another cooperating UE 115 such that another cooperating UE 115 has better instantaneous metrics to operate as the assisting UE 115. For example, the UE 115-a may experience worse signal quality or may move away from the other cooperating UEs 205 such that the UE 115-b has better metrics to operate as the assisting UE 115. The cooperating UEs 205 may perform another procedure to select the UE 115-b as the assisting UE 115, resulting in increased overhead and power consumption for the cooperating UEs 205. If instantaneous metrics continue to change, the cooperating UEs 205 may enter a cycle of repeatedly reselecting the assisting UE 115, in some examples ping-ponging between two candidate UEs 115.

The signaling diagram 200 may support to select an assisting UE 115 based on predictions. For example, the signaling diagram 200 may support selection of an assisting UE 115 based on temporal (e.g., future) predictions. In some examples, the assisting UE 115 may be selected based on a link quality prediction. For example, if a candidate UE 115 of the cooperating UEs 205 predicts signal quality or link quality degradation (e.g., due to predicting a decrease in RSRP measurement), the prediction of decreased link quality may indicate that the candidate UE 115 should not be selected as the assisting UE 115. In some other examples, a candidate UE 115 may predict that link quality is about to increase, which may make the candidate UE 115 a more suitable candidate to operate as the assisting UE 115 in the future.

In some examples, the assisting UE 115 may be selected based on UE traffic predictions. For example, if a candidate UE 115 predicts that it will have less traffic in the future, this may correspond to the candidate UE 115 having more energy for helping the cooperating UEs 205 in the future. In some other examples, a candidate UE 115 that predicts it will have increased traffic may correspond to the candidate UE 115 being too busy to operate as the assisting UE 115. In some examples, the assisting UE 115 may be selected based on UE mobility predictions. For example, a candidate UE 115 predicted to move away from co-located UEs 115 may break UE cooperation sooner than other candidate UEs 115, and another candidate UE 115 (e.g., which is predicted to stay closer to the co-located UEs 115) should be preferred to be selected as the assisting UE 115. In some examples, the assisting UE 115 may be selected based on battery consumption predictions. For example, a candidate UE 115 may have high battery at the time of assisting UE 115 selection, but the candidate UE 115 may predict that it is expected to engage in a battery consuming activity which may reduce the battery level of the candidate UE 115 soon. For example, the candidate UE 115 may predict it is expected to stream video, and the candidate UE 115 may prefer to save battery level for the battery consuming activity instead of operating as the assisting UE 115. In some other examples, a candidate UE 115 with a lower battery level may predict it is about to charge its battery or be plugged in soon, which may indicate that the candidate UE 115 may be able to operate as the assisting UE 115.

In some examples, the assisting UE 115 may be selected from the cooperating UEs 205 based on one or more instantaneous criteria as well as one or more predictions. For example, the assisting UE 115 may be selected based on instantaneous battery level, RRC status, supported features, instantaneous or filtered link quality (e.g., RSRP-to-cell), link quality prediction, traffic prediction, mobility prediction, battery consumption prediction, or any combination thereof.

For example, a UE 115-a may determine an instantaneous battery level and a battery level prediction for the UE 115-a. The UE 115-a may determine, for example, its battery level at a first time 220 (e.g., time T₀) for the instantaneous battery level. The UE 115-a may predict its battery consumption, for example, over a prediction window between the first time 220 and a second time 225 (e.g., time T). A device that selects the assisting UE 115 may make the selection based on, for example, the instantaneous battery level of the UE 115-a and the battery consumption prediction of the UE 115-a (e.g., the predicted battery level at the second time 225).

In some examples, a length of the prediction window (e.g., duration in time) may be configured (e.g., via communication of one or more control messages) by the network entity 105-a or a third-party application. In some examples, the cooperating UEs 205 may determine the length of the prediction window. For example, the cooperating UEs 205 may determine the second time 225 or the length of the prediction window based on a common threshold identified by the cooperating UEs 205. In some examples, a UE 115 may perform a prediction for a metric based on historical data through statistical models for time series forecasting (e.g., using autoregressive moving average or autoregressive integrated moving average models). In some examples, a UE 115 may perform a prediction for a metric using artificial intelligence or machine learning techniques (e.g., using recurrent neural network models).

The signaling diagram 200 may support signaling to exchange proposed metrics and associated predicted values for the metrics. For example, the cooperating UEs 205 may communicate the proposed metrics and associated predicted values via the communication links 210. Additionally, or alternatively, the cooperating UEs 205 may communicate the proposed metrics with a third-party entity or control entity, such as the network entity 105-a or an over-the-top (OTT) application. For example, signaling may be supported (e.g., on a local wireless interface between UEs and/or with the third-party/control entity such as NW or OTT application) to exchange proposed metrics and associated predicted values.

In some examples, the cooperating UEs 205 may be configured with a prediction window and one or more thresholds for one or more metrics or one or more criteria involved in the assisting UE 115 selection process. For example, the cooperating UEs 205 may be configured with a traffic threshold or an RSRP threshold, or both. The thresholds may be used to determine a score that can be used to elect a group of candidate UEs 115. In some examples, the cooperating UEs 205 may be configured with a time resolution for predictions in the prediction window, or a total quantity of predictions, N, within the prediction window, T. For example, each UE 115 of the cooperating UEs 205 may obtain N predictions (e.g., or N predicted samples) within the prediction window (e.g., between the first time 220 and the second time 225) for each metric that is evaluated to select the assisting UE 115.

In some examples, the predictions of a UE 115 may be compared to a threshold to determine a score for the UE 115 with respect to that metric. For example, the UE 115-a may obtain N predicted metric values for a certain metric within a time window of length T (e.g., the prediction window). The UE 115-a, or another device, may use the N predicted metric values of UE 115-a to determine whether the UE 115-ais a good candidate to operate as the assisting UE 115 with respect to that metric. In some examples, different metrics or prediction criteria may be used for different types of UE cooperation. For example, the cooperating UEs 205 may obtain and evaluate predictions for different criteria when selecting an assisting UE 115 for different scenarios.

In some examples, each individual UE 115 may be responsible for determining predictions and scores. Each UE 115 of the cooperating UEs 205 may determine predictions for metrics and compare the predictions for the metrics to corresponding thresholds associated with the metrics. For example, the UE 115-a may be configured with a threshold for a criterion, and the UE 115-a may compare predictions for the criterion to the threshold for the criterion.

In some other examples, another entity may determine the predictions or scores associated with the predictions, or both. For example, the UE 115-a report measurements or predictions, or both, for the criterion to another device, and the other device may compare the predictions to corresponding thresholds.

In some examples, a last time-predicted value for a criterion may be compared to a threshold for that criterion. For example, a predicted value for a criterion at the second time 225 (e.g., T) may be compared to the threshold for the criterion. If the predicted value for the criterion satisfies the threshold, the UE 115-a may be considered a good candidate to operate as the assisting UE 115 with respect to that at criterion. For example, the UE 115-a may compare a predicted link quality at the second time 225 to a link quality threshold. If the predicted link quality at the second time 225 satisfies the link quality threshold, the UE 115-a may be considered a suitable candidate to be the assisting UE 115 for the cooperating UEs 205.

Additional or alternative techniques may also be used to compare predicted metrics to thresholds to determine whether a UE 115 is a good candidate to operate as the assisting UE 115. For example, the UE 115-a may take an average of the N predicted samples for a metric over the prediction window and compare the average predicted value to a threshold for the metric. In some examples, the UE 115-a may count a quantity of predictions (e.g., of the N predictions) for a criterion which satisfy a threshold associated with the criterion. For example, the UE 115-a may count a quantity of samples in the window that are greater than a corresponding threshold for that metric and may report the corresponding quantity of predictions that are greater than the corresponding threshold.

In some examples, selecting an assisting UE 115 based on too few criteria may lead to a less accurate selection. However, using too many criteria or metrics may complicate the selection process. The signaling diagram 200 may support techniques to determine a single metric (e.g., a single score) that is representative of multiple criteria, and the single metric may be used to select the assisting UE 115.

For example, the signaling diagram 200 may support mapping from a set of potential criteria predictions or prediction scores to a single metric or score, M, and the single metric may be used to select an assisting UE 115. The metric M for each candidate UE 115 may be based on one or more criterion or predictions described herein (e.g., a subset or up to all criteria). For example, M may be based on one or more predictions or one or more instantaneous metrics, or any combination thereof (e.g., any combination of instantaneous or predicted criteria may be used). In some examples, each UE 115 of the cooperating UEs 205 may be configured with a mapping function between one or more criteria predictions or one or more criteria scores to the metric M. For example, the metric M may be computed as a linear combination of the scores for each criterion considered for assisting UE 115 selection. Each criterion or metric may be assigned a weighting factor based on priority of the metric. For example, a link quality prediction may be considered higher priority than a UE traffic prediction, so the link quality prediction may be assigned a higher weighting factor in determining M for a candidate UE 115 than the UE traffic prediction. In some examples, predictions before computing individual scores for a metric may be input to a machine learning model which will predict the metric M. In some examples, if a machine learning model is used to determine M, the cooperating UEs 205 may not be configured with thresholds or compare predictions to thresholds. The machine learning model may be configured with or determine a mapping between the set of temporal predictions and M.

In some examples, the network entity 105-a may configure a mapping function between criteria and the single metric M. As discussed herein, configuring may refer to communicating control signaling or one or more control messages. For example, the network entity 105-a may transmit control signaling to each of the cooperating UEs 205 that indicates the mapping function between the single metric M and predictions or measurements for the criteria. In some other examples, the cooperating UEs 205 may determine the mapping function. For example, the cooperating UEs 205 may communicate via the communication links 210 to determine the mapping function (e.g., without additional input from the network or the network entity 105-a). In some examples, the single metric M may be use-case specific. For example, a first scenario of UE cooperation may use a first metric M, and a second scenario of UE cooperation may use a second metric M which may be different from the first metric M (e.g., use a different mapping function or be determined based on different criteria). In some examples, the metric M for a UE 115 may change over time. For example, if a metric M for a UE 115 is based on instantaneous measurements or the prediction window changes, the metric M for the UE 115 may change.

The signaling diagram 200 may support signaling to exchange parameter information (e.g., metrics) for assisting UE 115 selection. In some examples, the UEs 115 of the cooperating UEs 205 may exchange parameter information. Additionally, or alternatively, one or more UEs 115 of the cooperating UEs 205 may send parameter information to the network entity 105-a or a third-party entity that selects the assisting UE 115. Candidate UEs 115 involved in selecting the assisting UE 115 may exchange individually computed metric scores M among each other to perform a selection of the assisting UE 115. In some examples, the network entity 105-a or a third-party entity may obtain the scores (e.g., M for each candidate UE 115) for the candidate UEs 115 and select the assisting UE 115 based on the scores for the candidate UEs 115.

For example, the candidate UEs 115 may locally select an assisting UE 115. In this example, the UE 115-a, the UE 115-b, and the UE 115-c may be cooperating UEs 205 which select an assisting UE 115. Each of the cooperating UEs 205 may determine a respective metric M based on at least one criterion used to select the assisting UE 115. The cooperating UEs 205 may exchange their computed metric M via communication links 210. For example, the UE 115-a and the UE 115-b may exchange computed metrics M via a communication link 210-a, and the UE 115-a and the UE 115-c may exchange computed metrics M via a communication link 210-b.

In some examples, a device may operate as a coordinator (e.g., a coordinating device). The coordinating device may advertise a possibility of UE collaboration or UE cooperation. In some examples, the coordinating device may obtain metrics or values of at least one criterion used to select an assisting UE 115 from different candidate UEs 115. In some examples, the coordinating device may determine the assisting UE 115 based on the metrics of the candidate UEs 115.

In some cases, candidate UEs may locally elect the assisting UE. To do so, the candidate UEs may They can exchange the computed metric scores through at least one local communication link (e.g., Bluetooth, Wi-Fi, NR Sidelink). One candidate UE may act as a ‘coordinator’ for the cooperation group (e.g., advertising the possibility of collaboration, receiving one or more metrics M, and performing the decision). In some examples, the coordinator UE may also decide which one or more criteria to use in the selection process of the assisting UE, a weighting factor for each of the one or more criteria, or the like. In some other examples, a network entity 105 or other entity (e.g., a third-party application) may manage UE cooperation. The network entity 105 or other entity may receive the one or more metrics M, select the assisting UE (e.g., act as coordinator), and notify the UEs of the selected assisting UE. In other words, the network entity 105 or other entity may be responsible for coordinating a group of cooperating UEs.

For example, the UE 115-a may operate as the coordinating device. The UE 115-b may determine metrics associated with the UE 115-b operating as the assisting UE 115 and send parameter information (e.g., based on or including the metrics) to the UE 115-a. The parameter information may, for example, include one or more predictions, one or more instantaneous measurements, a single metric which is representative of multiple criteria, or any combination hereof. The UE 115-a may also receive, from the UE 115-c, parameter information associated with the UE 115-c operating as the assisting UE 115. The UE 115-a may determine its own parameter information associated with the UE 115-a operating as the assisting UE 115. The UE 115-a may determine which, of the candidate UEs 115 (e.g., between the UE 115-a, the UE 115-b, and the UE 115-c) is to be selected as the assisting UE 115 based on the parameter information for the UE 115-a, the UE 115-b, and the UE 115-c. In some examples, the selected UE 115 may have the highest score or highest metrics among the candidate UEs 115. For example, the UE 115-a may select the UE 115 which a highest M score among the UE 115-a, the UE 115-b, and the UE 115-c. The UE 115-a may transmit selection information that indicates the UE 115 selected to operate as the assisting UE 115 to the other cooperating UEs 205.

In some examples, a different entity may determine the assisting UE 115. For example, the network entity 105-a or a separate (e.g., third-party) entity may receive the metrics for the candidate UEs 115 and select one of the candidate UEs 115 to operate as the assisting UE 115. For example, the network entity 105-a may obtain metrics for the UE 115-a, the UE 115-b, and the UE 115-c, and the network entity 105-a may select one of the UEs 115 to operate as the assisting UE 115. The network entity 105-a may transmit an indication of the selected UE 115 to the cooperating UEs 205. In this example, the network entity 105-a may be an example of a coordinating device. A final elected delegate or assisting UE 115 may correspond to a UE 115 with a highest score for the metric M among the candidate UEs 115. In some examples, candidate UEs involved in the decision process of selecting the assisting UE may exchange individually computed metric scores M among each other to perform a final decision. In some cases, the candidate UEs may elect one UE to make the final decision in the event of a tie. Alternatively, or additionally, the network entity 105-a or a separate (e.g., third-party) may compute or receive the scores (M) and perform a final decision.

The signaling diagram 200 may support techniques to maintain an assisting UE 115 selection. For example, the assisting UE 115 may be maintained or switched based on one or more of at least one spatial aspect, at least one temporal aspect, or both. If the cooperating UEs 205 have selected an assisting UE 115, the assisting UE 115 may need to continue to be able to operate as the assisting UE 115. The current assisting UE 115 may be checked (e.g., periodically) on its ability to continue operation as the assisting UE 115. If the assisting UE 115 cannot continue to operate as the assisting UE 115, a new assisting UE 115 may be selected. Reselecting an assisting UE 115 may be similar to cell reselection, where a UE 115 may continuously check candidate cells against a serving cell and perform a handover to a candidate cell with better measurements (e.g., the candidate cell has a higher RSRP measurement for a duration than the serving cell).

For example, the UE 115-a may be selected as the assisting UE 115 based on having one or more higher metrics than the UE 115-b or the UE 115-c (e.g., having a higher score for metric M among at least a subset of the candidate UEs). The cooperating UEs 205 may check metrics of the UE 115-a periodically to determine whether the UE 115-a is able to continue operating as the assisting UE 115. In some examples, the metrics of the assisting UE 115 may be checked periodically. The network entity 105-a may configure a periodicity to check eligibility of the assisting UE 115. In some other examples, the cooperating UEs 205 may determine the periodicity to check the eligibility of the assisting UE 115 (e.g., evaluate the metrics or score of the assisting UE 115).

In some examples, the metrics of the assisting UE 115 may be checked on-demand. For example, the network entity 105-a may trigger the assisting UE 115 to report a delegation status. If the UE 115-a is operating as the assisting UE 115, the network entity 105-a may configure the UE 115-a to report whether the UE 115-a can continue operating as the assisting UE 115. In some examples, the UE 115-a may determine metrics associated with operating as the assisting UE 115, and the UE 115-amay report its metrics. For example, the UE 115-a may determine an updated metric M based on predictions or instantaneous measurements and report the updated metric M. In case of local coordination (e.g., the cooperating UEs 205 locally select the assisting UE 115), an assisted UE 115 of the cooperating UEs 205 may trigger the currently selected assisting UE 115 to report a status of the currently selected assisting UE 115.

In some examples, candidate UEs 115 of the cooperating UEs 205 may indicate a duration associated with operating as an assisting UE 115. For example, for assisting UE 115 selection or reselection, a candidate UE 115 may indicate a duration during which the candidate UE 115 may be able to operate as the assisting UE 115. Selection of the assisting UE 115 may be based on the timing information. For example a candidate UE 115 that can operate as the assisting UE 115 for longer may be a better selection as the assisting UE 115. In some examples, a coordinating device may use the timing information to determine when to select a new assisting UE 115. For example, the UE 115-a may operate as a first assisting UE 115, and the UE 115-a may have indicated that it can operate as the assisting UE 115 for a first duration. Toward an end of the first duration, a coordinating device may determine to select a new assisting UE 115. For example, the coordinating device may proactively search for a new delegate UE towards the expiration time of the first duration (e.g., perform proactive delegate reselection).

In some examples, a candidate UE 115 may indicate an area (e.g., geo-location) in which the candidate UE 115 may be able to operate as an assisting UE 115. For example, the UE 115-a may indicate location information associated with the UE 115-a operating as the assisting UE 115. If the UE 115-a is selected as the assisting UE 115, and the UE 115-a moves outside of the indicated area, the cooperating UEs 205 may determine to select a new assisting UE 115.

In some examples, a candidate UE 115 may indicate UE behavior information associated with operating as an assisting UE 115. For example, a candidate UE 115 may indicate behavior patterns for the candidate UE 115. In some examples, the candidate UE 115 may indicate timing information associated with different behaviors. For example, the candidate UE 115 may indicate a time interval during which the candidate UE 115 is usually in a particular geographic area or is operating in certain RRC states. UE cooperation techniques and assisting UE 115 selection or reselection may be based on UE behavior for the different candidate UEs 115.

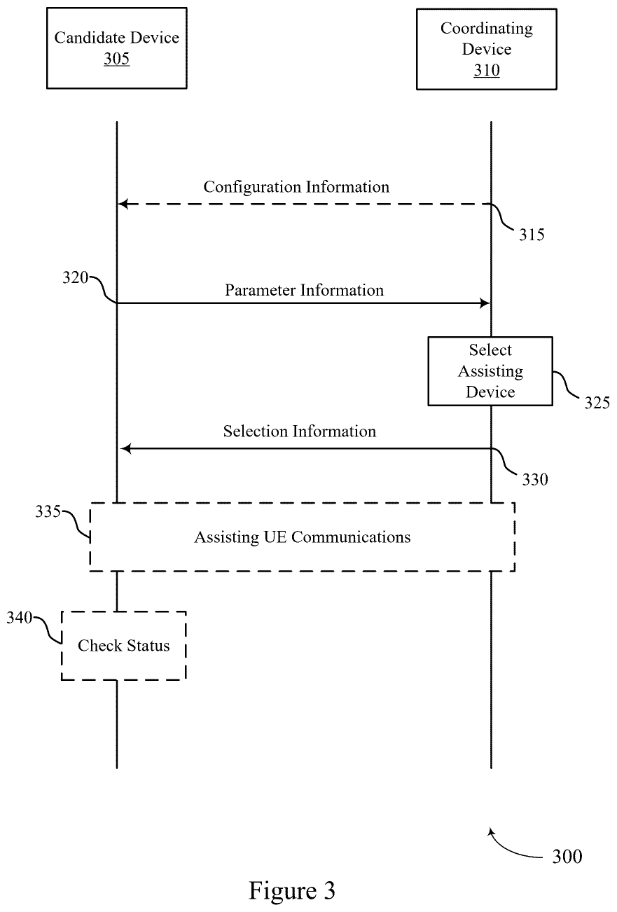

FIG. 3 shows an example of a process flow 300 that supports selecting an assisting device. The process flow 300 may implement, or be implemented by, aspects of the wireless communications system 100, the signaling diagram 200, or any combination thereof.

For example, the process flow 300 may illustrate a communications flow or call flow between a candidate device 305 and a coordinating device 310, which may be examples of the corresponding devices as described with reference to FIG. 1-2. The candidate device 305 may be an example of a UE 115, such as a UE 115 participating in UE cooperation. The coordinating device 310 may be an example of a UE 115 or a network entity 105 as described herein. For example, the coordinating device 310 may be a UE 115 participating in UE cooperation, or the coordinating device 310 may be a separate entity, such as a network entity 105 or a third-party control entity. In some examples, a group of cooperating UEs 115 may include the candidate device 305 and one or more other devices (e.g., UEs 115).

The process flow 300 may illustrate processes and signaling to select an assisting UE 115 from a group of cooperating UEs 115. In some examples, the cooperating UEs 115 may determine (e.g., transparent to the network) the assisting UE 115. For example, one of the cooperating UEs 115 may be an example of the coordinating device 310 which obtains parameter information from candidate UEs 115 and selects the assisting UE 115. In some other examples, a separate entity (e.g., a network entity 105 or a third-party entity) may obtain parameter information from candidate UEs 115 and select the assisting UE 115 for the cooperating UEs 115.

In some examples, at 315, the coordinating device 310 may send configuration information to the cooperating UEs 115. For example, the candidate device 305 may receive configuration information for selection of the assisting UE 115. In some examples, the configuration information may include an indication of metrics or predictions the are used to select the assisting UE 115. In some examples, the configuration information may include a prediction window associated with obtaining the predictions. In some examples, the configuration information may include threshold information for obtaining the predictions or scores that are based on the predictions. In some examples, the configuration information may include a quantity of samples associated with the prediction window. For example, the configuration information may indicate a quantity of predictions the candidate device 305 is to perform or obtain for the prediction window.

In some examples, the configuration information may be associated with determination of parameter information. For example, the configuration information may indicate to the candidate device 305 how to determine parameter information associated with the candidate device 305 operating as the assisting UE 115. For example, the configuration information may indicate which metrics the candidate device 305 is to determine or predict to determine whether the candidate device 305 is suitable to operate as the assisting UE 115.

In some examples, the coordinating device 310 may also be an example of a candidate UE 115. For example, the coordinating device 310 and the candidate device 305 may receive the configuration information from a network entity 105. In some other examples, the coordinating device 310 may be a network entity 105, and the coordinating device 310 may transmit the configuration information to candidate UEs 115.

The candidate device 305 may determine parameter information associated with the candidate device 305 operating as the assisting UE 115. The candidate device 305 may predict one or metrics associated with the candidate device 305 operating as the assisting UE 115. The predicted metrics may include, for example, a link quality prediction, a traffic prediction, a mobility prediction, a battery consumption prediction, or any combination thereof. In some examples, the candidate device 305 may determine multiple predictions for each of the one or more predicted metrics. For example, the candidate device 305 may predict N link quality predictions over the course of a prediction window.

In some examples, the candidate device 305 may determine one or more scores associated with the predicted metrics. For example, the candidate device 305 may be configured with one or more thresholds corresponding to the one or more predicted metrics. The candidate device 305 may compare metric predictions to a corresponding threshold to determine a score associated with that predicted metric. For example, the candidate device 305 may determine whether a furthest (e.g., in time) prediction of a metric satisfies a threshold. Additionally, or alternatively, the candidate device 305 may determine a quantity of predictions (e.g., of the N predictions taken for the prediction window) that satisfy a threshold. In some examples, the candidate device 305 may determine whether an average of the predictions (e.g., and average of the N predictions) satisfies a threshold. The candidate device 305 may determine a score for a metric based on comparing predictions for that metric to a threshold.

In some examples, the candidate device 305 may determine one or more instantaneous metrics associated with the candidate device 305 operating as the assisting UE 115. The instantaneous metrics may include an instantaneous battery level, an RRC status of the candidate device, supported features o the candidate device 305, an instantaneous link quality, or a filtered link quality, or any combination thereof.

In some examples, the candidate device 305 may determine a single metric that is representative of one or more other metrics. For example, the candidate device 305 may determine a metric M that is representative of one or more metrics. The metric M may be based on predictions or instantaneous metrics, or both. In some examples, the candidate device 305 may determine the single metric M based on a mapping function of other metrics. For example, the single metric M may be based on a linear combination of instantaneous metrics or predicted metrics, or both. In some other examples, the candidate device 305 may transmit an indication of the instantaneous metrics or predicted metrics, or both, to the coordinating device 310, and the coordinating device 310 may determine a single metric M for the candidate device 305.

In some examples, the coordinating device 310 may also be one of the cooperating UEs 115. The coordinating device 310 may determine parameter information associated with the coordinating device 310 operating as the assisting UE 115. For example, the coordinating device 310 may determine one or more instantaneous metrics or one or more predictions associated with operating as the assisting UE 115. In some examples, the coordinating device 310 may determine a single metric M for the coordinating device 310 that is representative of one or more instantaneous metrics or predictions or both.

At 320, the candidate device 305 may transmit parameter information to the coordinating device 310. For example, the candidate device 305 may transmit parameter information for selection of an assisting UE 115 from the cooperating UEs 115. The parameter information may be based on one or more predictions associated with the candidate device 305 operating as the assisting UE 115.

The coordinating device 310 may receive the parameter information from the candidate device 305. In some examples, the coordinating device 310 may receive parameter information from multiple candidate devices. For example, the coordinating device 310 may receive, from one or more UEs of the cooperating UEs 115, parameter information for the selection of the assisting UE 115 from the cooperating UEs 115.

The coordinating device 310 may select an assisting device for the cooperating UEs 115 at 325. For example, the coordinating device 310 may select one of the candidate UEs 115 to operate as the assisting UE 115 for the cooperating UEs 115.

In some examples, the coordinating device 310 may select a UE 115 that has a highest metric to operate as the assisting UE 115. For example, the coordinating device 310 may compare metrics M for each candidate UE 115, and the coordinating device 310 may select a UE 115 which has a highest metric M to operate as the assisting device. In some examples, the coordinating device may evaluate parameter information (e.g., including one or more predictions or one or more instantaneous metrics, or both) for each of the candidate UEs 115 and select the assisting UE 115 based on the parameter information for each of the candidate UEs 115.

At 330, the coordinating device 310 may transmit selection information to the cooperating UEs 115. For example, the coordinating device 310 may transmit, to the one or more UEs 115, selection information that includes an indication of a first UE 115 selected from the cooperating UEs 115 to operate as the assisting UE 115 based on the parameter information. For example, the candidate device 305 may receive, from the coordinating device 310, the selection information that indicates the first UE 115 from the cooperating UEs 115.

In some examples, the candidate device 305 or the coordinating device 310, or both, may communicate with a network entity 105 via the assisting UE 115 at 335. For example, the candidate device 305 may transmit information to or receive information from the network entity 105 via the assisting UE 115.

In some examples, the candidate device 305 may be selected as the assisting UE 115. The candidate device 305 may communicate with a network entity 105 on behalf of the other cooperating UEs 115, operating as the assisting UE 115. In some examples, the coordinating device 310 may be selected as the assisting UE 115. The coordinating device 310 may communicate with a network entity 105 on behalf of the other cooperating UEs 115 (e.g., including the candidate device 305), operating as the assisting UE 115.

In some examples, the cooperating UEs 115 may check a status of the assisting UE 115 at 340. For example, the cooperating UEs 115 may check whether the currently selected assisting UE 115 is suitable to continue operating as the assisting UE 115. In some examples, the candidate device 305 may transmit signaling to query the assisting UE 115 on its status. If metrics for the currently selected assisting UE 115 have worsened, the cooperating UEs 115 may select another candidate UE 115 to operate as the assisting UE 115.

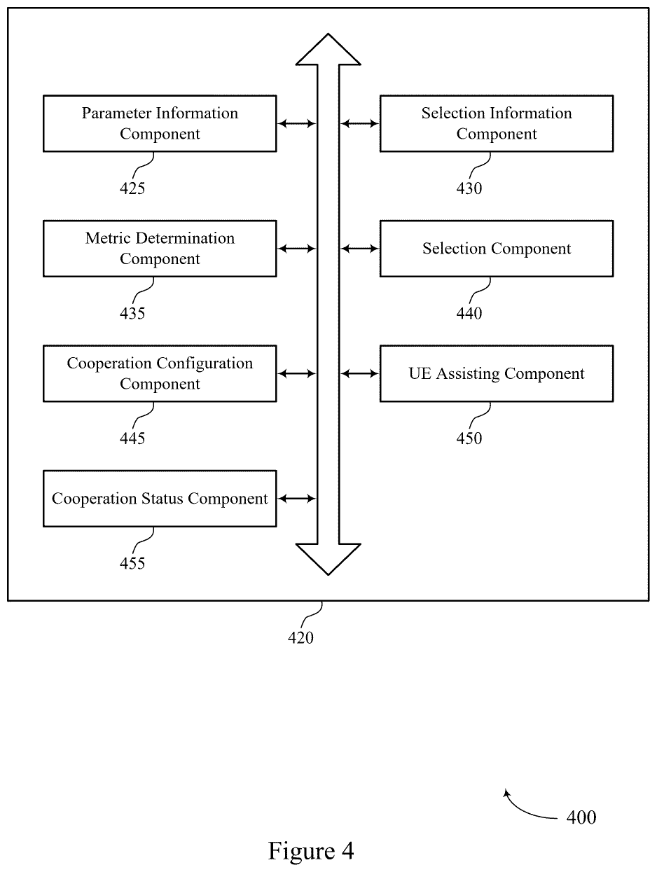

FIG. 4 shows an example of a processing system 420 that supports selecting an assisting device. A processing system 420 may be an example of a processing system 140 (such as of a UE 115) and may include a parameter information component 425, a selection information component 430, a metric determination component 435, a selection component 440, a cooperation configuration component 445, a UE assisting component 450, a cooperation status component 455, or any combination thereof. A processing system 420, or various component thereof, may be an example of means for performing (such as a means for causing a UE 115 to perform) various techniques described herein.

The parameter information component 425 may be configured to cause the UE 115 to receive, from one or more UEs of a set of multiple cooperating UEs, parameter information for selection of an assisting UE from the set of multiple cooperating UEs to communicate with a network entity on behalf of the set of multiple cooperating UEs, where the parameter information is based on one or more predictions associated with the one or more UEs operating as the assisting UE. The selection information component 430 may be configured to cause the UE 115 to transmit, to the one or more UEs, selection information including an indication of a first UE selected from the set of multiple cooperating UEs to operate as the assisting UE based on the parameter information.

In some examples, the metric determination component 435 may be configured to cause the UE 115 to determine, for each of the set of multiple cooperating UEs, a metric based on respective parameter information of the set of multiple cooperating UEs. In some examples, the selection component 440 may be configured to cause the UE 115 to select the first UE from the set of multiple cooperating UEs to operate as the assisting UE based on a first metric for the first UE having a highest value among the set of multiple cooperating UEs.

In some examples, the metric for the first UE is based on a linear combination of a set of multiple parameters of the first UE.

In some examples, the cooperation configuration component 445 may be configured to cause the UE 115 to receive, from the network entity, configuration information for the selection of the assisting UE, where the configuration information includes a mapping function between the parameter information and a metric that is representative of the parameter information.

In some examples, the cooperation configuration component 445 may be configured to cause the UE 115 to receive, from the network entity, configuration information for the selection of the assisting UE, where the configuration information includes an indication of the one or more predictions, prediction window information, threshold information, a quantity of samples associated with the prediction window information, or any combination thereof.

In some examples, the metric determination component 435 may be configured to cause the UE 115 to transmit, to the one or more UEs, configuration information for determination of the parameter information, where the configuration information identifies the one or more predictions.

In some examples, the configuration information includes a duration associated with the one or more predictions, one or more thresholds associated with the one or more predictions, a quantity of prediction determinations associated with the duration, or any combination thereof.

In some examples, the one or more predictions includes a link quality prediction, a traffic prediction, a mobility prediction, a battery consumption prediction, or any combination thereof.

In some examples, the selection component 440 may be configured to cause the UE 115 to select the first UE from the set of multiple cooperating UEs based on UE behavior information indicated by the parameter information.

In some examples, the selection component 440 may be configured to cause the UE 115 to select the device from the set of multiple cooperating UEs as the assisting UE. In some examples, the UE assisting component 450 may be configured to cause the UE 115 to communicate, as the assisting UE, information with the network entity on behalf of the set of multiple cooperating UEs.

In some examples, the selection information includes a duration associated with operation of the first UE as the assisting UE.

In some examples, the parameter information includes area information associated with operation as the assisting UE.

In some examples, the cooperation status component 455 may be configured to cause the UE 115 to transmit, to the first UE, a request for a status of the first UE as the assisting UE. In some examples, the cooperation status component 455 may be configured to cause the UE 115 to receive, from the first UE, status information associated with the first UE operating as the assisting UE.

In some examples, the parameter information component 425 may be configured to cause the UE 115 to transmit, to a coordinating device, parameter information for selection of an assisting UE from a set of multiple cooperating UEs to communicate with a network entity on behalf of the set of multiple cooperating UEs where the parameter information is based on one or more predictions associated with the first UE operating as the assisting UE. In some examples, the selection information component 430 may be configured to cause the UE 115 to receive, from the coordinating device, selection information including an indication of a second UE selected from the set of multiple cooperating UEs to operate as the assisting UE based on the parameter information.

In some examples, the metric determination component 435 may be configured to cause the UE 115 to determine, for the first UE, a metric based on a linear combination of a set of multiple parameters including at least the one or more predictions, where the parameter information includes the metric.

In some examples, the cooperation configuration component 445 may be configured to cause the UE 115 to receive, from a network entity, configuration information for the selection of the assisting UE, where the configuration information includes an indication of the one or more predictions, prediction window information, threshold information, a quantity of samples associated with the prediction window information, or any combination thereof.

In some examples, the cooperation configuration component 445 may be configured to cause the UE 115 to receive, from the coordinating device, configuration information for determination of the parameter information, where the configuration information identifies the one or more predictions.

In some examples, the configuration information includes a duration associated with the one or more predictions, one or more thresholds associated with the one or more predictions, a quantity of prediction determinations associated with the duration, or any combination thereof.

In some examples, the one or more predictions includes a link quality prediction, a traffic prediction, a mobility prediction, a battery consumption prediction, or any combination thereof.

In some examples, the selection information includes a duration associated with operation of the second UE as the assisting UE.

In some examples, the parameter information includes area information associated with the first UE operating as the assisting UE.

In some examples, the parameter information includes UE behavior information associated with the first UE.

In some examples, the UE assisting component 450 may be configured to cause the UE 115 to communicate, via the assisting UE, information with a network entity.

In some examples, the UE assisting component 450 may be configured to cause the UE 115 to communicate, as the assisting UE, information with the network entity on behalf of the set of multiple cooperating UEs, where the selection information identifies the first UE as the assisting UE, and where the first UE and the second UE are the same.

A processing system 420 may include or be a component of one or more chips, systems-on-chips (SoCs), chipsets, packages, components, or devices that individually or collectively constitute or include a processing system. A processing system 420 may interface with other components of a processing system 420. For example, operations described with reference to a processing system 420, or various components thereof, may be performed by or with other such components, including a receiver, a transmitter, a transceiver, a modem, a user interface, a modulator/demodulator, an encoder/decoder, or any combination thereof (such as of the processing system 420, coupled with the processing system 420, of a processing system 420).

By including or configuring a processing system 420 for operation in a processing system 420 as described herein, the processing system 420 may support techniques for reduced processing, reduced power consumption, and more efficient utilization of communication resources.

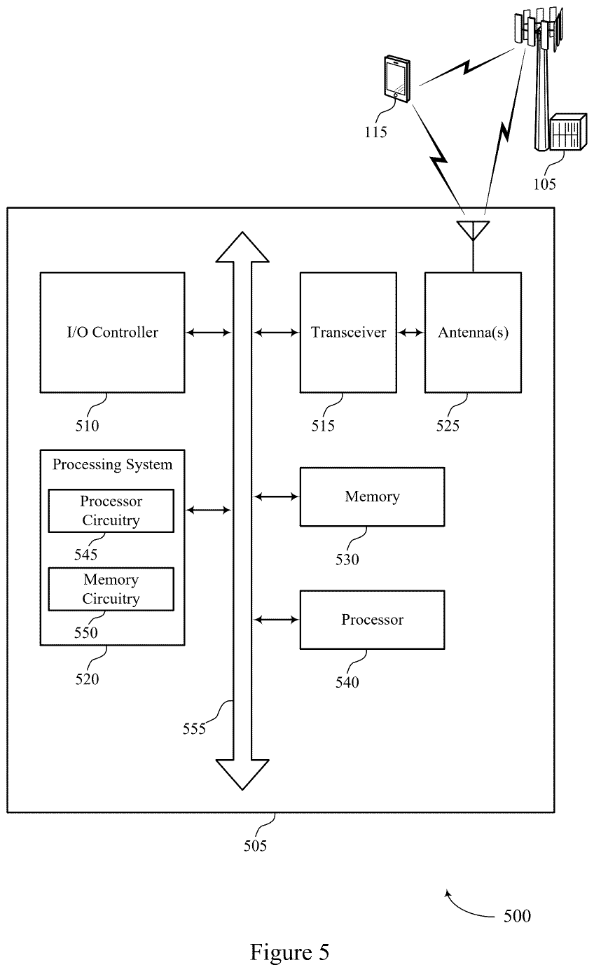

FIG. 5 shows an example of a system 500 including a device 505 that supports selecting an assisting device. The device 505 may be an example of or include components of UE 115. The device 505 may communicate (such as wirelessly) with one or more other devices (such as network entities 105, UEs 115). The device 505 may include components for transmitting and receiving communication, which may include a processing system 520, an input/output (I/O) controller, such as an I/O controller 510, a transceiver 515, antenna(s) 525, a memory 530, and a processor 540. Components of the device 505 may be coupled (such as operatively, communicatively, functionally, electronically, electrically, in electronic communication) a bus 555.

The transceiver 515 may support bi-directional communication via antenna(s) 525, and may support transmission operations, reception operations, or both, as described herein. The transceiver 515 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 505). The transceiver 515 may modulate symbols and provide the modulated symbols to antenna(s) 525 for transmission, and demodulate symbols from signals received using antenna(s) 525.

The processor 540 may be a general-purpose processing component that supports various operations (such as applications) of the device 505. The memory 530 may be a general-purpose storage component that stores code executable by the processor 540. Such code may include instructions that, when executed by the processor 540, cause the device 505 to perform various functions (such as to support an application of the device 505). The I/O controller 510 may manage inputs and outputs for the device 505, may manage peripherals not integrated into the device 505, or may represent a physical connection (such as port) to an external peripheral. The processor 540 may interact with a modem, a keyboard, a mouse, a touchscreen, or other device (such as via I/O controller 510). In some implementations, a user may interact with the device 505 via the I/O controller 510 or via hardware components controlled by the I/O controller 510.

The processing system 520 may be an example of a processing system 140 or a processing system 400. For example, the processing system 520 may include processor circuitry 545 and memory circuitry 550 that stores code, and may be configured to cause the device 505 to perform operations that support selecting an assisting device. Although the processing system 520 is illustrated as a separate component, which may involve a separate chip, chipset, or other module, in some implementations, one or more functions described with reference to the processing system 520 may be supported by or performed by a transceiver 515, antenna(s) 525, a processor 540, memory 530, or any combination thereof, such that a processing system 520 may include one or more of a transceiver 515, antenna(s) 525, a processor 540, memory 530, or any combination thereof.

By including or configuring the processing system 520 for operation in the device 505 as described herein, may support techniques for improved communication reliability, reduced latency, reduced power consumption, more efficient utilization of communication resources, and improved coordination between devices.

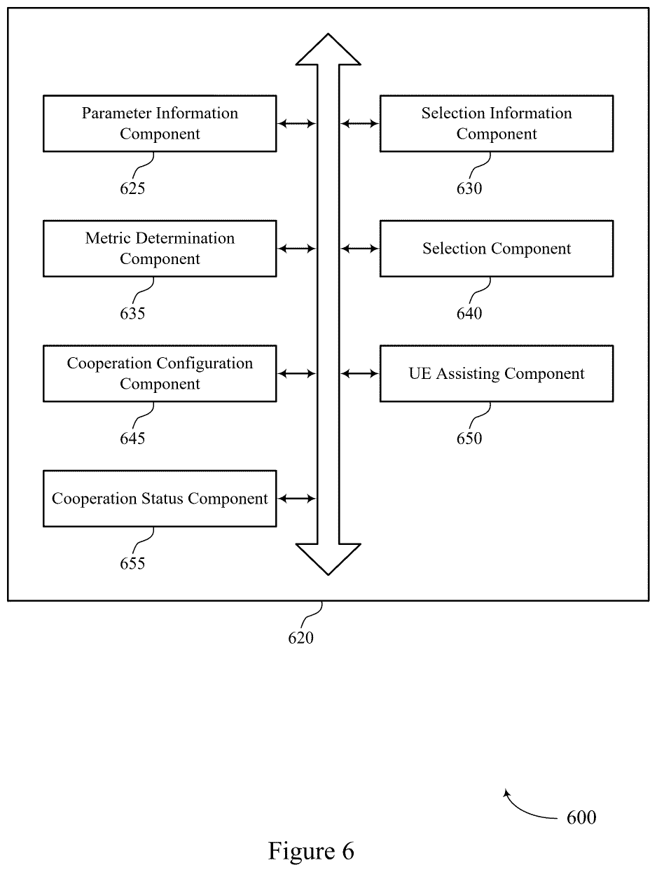

FIG. 6 shows an example of a processing system 620 that supports selecting an assisting device. A processing system 620 may be an example of a processing system 145 (such as network entity 105) and may include a parameter information component 625, a selection information component 630, a metric determination component 635, a selection component 640, a cooperation configuration component 645, a UE assisting component 650, a cooperation status component 655, or any combination thereof. A processing system 620, or various component thereof, may be an example of means for performing (such as a means for causing a network entity 105 to perform) various techniques described herein.

The parameter information component 625 may be configured to cause the network entity 105 to receive, from one or more UEs of a set of multiple cooperating UEs, parameter information for selection of an assisting UE from the set of multiple cooperating UEs to communicate with a network entity on behalf of the set of multiple cooperating UEs, where the parameter information is based on one or more predictions associated with the one or more UEs operating as the assisting UE. The selection information component 630 may be configured to cause the network entity 105 to transmit, to the one or more UEs, selection information including an indication of a first UE selected from the set of multiple cooperating UEs to operate as the assisting UE based on the parameter information.

In some examples, the metric determination component 635 may be configured to cause the network entity 105 to determine, for each of the set of multiple cooperating UEs, a metric based on respective parameter information of the set of multiple cooperating UEs. In some examples, the selection component 640 may be configured to cause the network entity 105 to select the first UE from the set of multiple cooperating UEs to operate as the assisting UE based on a first metric for the first UE having a highest value among the set of multiple cooperating UEs.

In some examples, the metric for the first UE is based on a linear combination of a set of multiple parameters of the first UE.

In some examples, the cooperation configuration component 645 may be configured to cause the network entity 105 to receive, from the network entity, configuration information for the selection of the assisting UE, where the configuration information includes a mapping function between the parameter information and a metric that is representative of the parameter information.

In some examples, the cooperation configuration component 645 may be configured to cause the network entity 105 to receive, from the network entity, configuration information for the selection of the assisting UE, where the configuration information includes an indication of the one or more predictions, prediction window information, threshold information, a quantity of samples associated with the prediction window information, or any combination thereof.

In some examples, the metric determination component 635 may be configured to cause the network entity 105 to transmit, to the one or more UEs, configuration information for determination of the parameter information, where the configuration information identifies the one or more predictions.

In some examples, the configuration information includes a duration associated with the one or more predictions, one or more thresholds associated with the one or more predictions, a quantity of prediction determinations associated with the duration, or any combination thereof.

In some examples, the one or more predictions includes a link quality prediction, a traffic prediction, a mobility prediction, a battery consumption prediction, or any combination thereof.

In some examples, the selection component 640 may be configured to cause the network entity 105 to select the first UE from the set of multiple cooperating UEs based on UE behavior information indicated by the parameter information.

In some examples, the selection component 640 may be configured to cause the network entity 105 to select the device from the set of multiple cooperating UEs as the assisting UE. In some examples, the UE assisting component 650 may be configured to cause the network entity 105 to communicate, as the assisting UE, information with the network entity on behalf of the set of multiple cooperating UEs.

In some examples, the selection information includes a duration associated with operation of the first UE as the assisting UE.

In some examples, the parameter information includes area information associated with operation as the assisting UE.

In some examples, the cooperation status component 655 may be configured to cause the network entity 105 to transmit, to the first UE, a request for a status of the first UE as the assisting UE. In some examples, the cooperation status component 655 may be configured to cause the network entity 105 to receive, from the first UE, status information associated with the first UE operating as the assisting UE.

A processing system 620 may include or be an example of one or more chips, SoCs, chipsets, packages, components, or devices that individually or collectively constitute or include a processing system. A processing system 620 may interface with other components of a network entity 105. For example, operations described with reference to a processing system 620, or various components thereof, may be performed by or with other such components, including a receiver, a transmitter, a transceiver, a modem, a user interface, a modulator/demodulator, an encoder/decoder, or any combination thereof (such as of the processing system 620, coupled with the processing system 620, of a network entity 105). Operations described herein with reference to the processing system 620, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 620 for operation in a processing system 620 as described herein, the processing system 620 may support techniques for reduced processing, reduced power consumption, and more efficient utilization of communication resources.

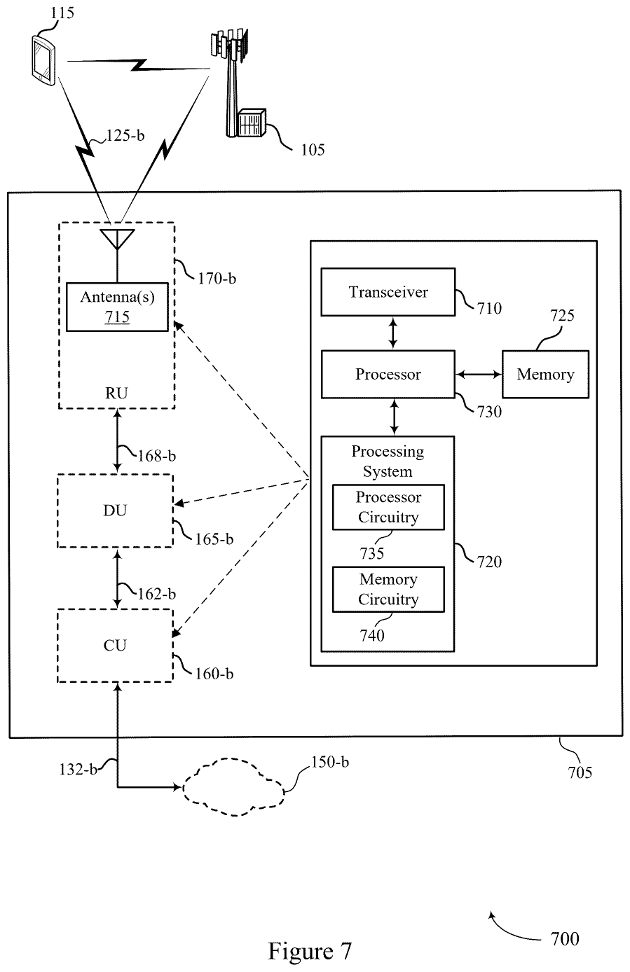

FIG. 7 shows an example of a system 700 including a device 705 that supports selecting an assisting device. The device 705 may communicate (such as via one or more wired interfaces or one or more wireless interfaces) with other network devices or network equipment such as a core network 150-b, other network entities 105, UEs 115, or any combination thereof. The device 705 may include components for transmitting and receiving communication, which may include a processing system 720, a transceiver 710, antenna(s) 715, a memory 725, and a processor 730. Components of the device 705 may be coupled (such as operatively, communicatively, functionally, electronically, electrically, in electronic communication) via one or more interfaces.

The transceiver 710 may communicate bi-directionally with another transceiver via wired or wireless links, and may support transmission operations, reception operations, or both, as described herein. The transceiver 710 may include a modem to modulate and demodulate signals, to provide the modulated signals for transmission (such as via antenna(s) 715, via a wired interface), and to demodulate received signals (such as received via antenna(s) 715, received via a wired interface). The transceiver 710 may be operable to support communication via one or more communication links (such as a communication link 125-b, a backhaul link 132-b, a midhaul link 162-b, fronthaul link 168-b).

The processor 730 may be a general-purpose processing component that supports various operations (such as applications) of the device 705. The memory 725 may be a general-purpose storage component that stores code executable by the processor 730. Such code may include instructions that, when executed by the processor 730, cause the device 705 to perform various functions (such as to support an application of the device 705).

For examples in which the device 705 is a network entity 105 in a disaggregated architecture, one or more components of the device 705 may be located at one or more of a CU 160-b, a DU 165-b, or an RU 170-b, one or more of which may include aspects of the processing system 720, the processor 730, the memory 725, or the transceiver 710. Functions of the device 705 may be performed at different components or an operation may be divided between different components (such as different functions being supported by aspects of the CU 160-b, the DU 165-b, or the RU 170-b, the transceiver 710, the processor 730, the memory 725, the processing system 720, or any combination thereof). For example, the processing system 720 may be a component of one or more of the CU 160-b, the DU 165-b, or the RU 170-b. In some examples, interfaces between components of device 705 (such as CU 160-b, DU 165-b, RU 170-b) may support communication at a protocol layer or between protocol layers of a protocol stack.

In some examples, the processing system 720 may manage aspects of communication with the core network 150-b (such as via a backhaul link 132). For example, the processing system 720 may manage the transfer of data communication for UEs 115 with a gateway of the core network 150-b. In some examples, the processing system 720 may manage communication with one or more other network entities 105 and may include a controller or scheduler for controlling communication with UEs 115 (such as in cooperation with the one or more other network entities 105). In some examples, the processing system 720 may support an interface (such as X2 interface, Xn interface) to provide communication between network entities 105.

The processing system 720 may be an example of a processing system 145 or a processing system 600. For example, the processing system 720 may include processor circuitry 735 and memory circuitry 740 that stores code, and the processing system 720 may be configured to cause the device 705 to perform operations that support selecting an assisting device. Although the processing system 720 is illustrated as a separate component, which may involve a separate chip, chipset, or other module, in some implementations, one or more functions described with reference to the processing system 720 may be supported by or performed by a transceiver 710, antenna(s) 715, a processor 730, memory 725, or any combination thereof, such that a processing system 720 may include one or more of a transceiver 710, antenna(s) 715, a processor 730, memory 725, or any combination thereof. Further, processor circuitry 735 and memory circuitry 740 each may be implemented at the device 705 in accordance with an aggregated architecture, or the processor circuitry 735 and the memory circuitry 740 may be implemented at one or more of a CU 160-b, a DU 165-b, or an RU 170-b in accordance with a disaggregated architecture.

By including or configuring the processing system 720 for operation in the device 705 as described herein, may support techniques for improved communication reliability, reduced latency, reduced power consumption, more efficient utilization of communication resources, and improved coordination between devices.

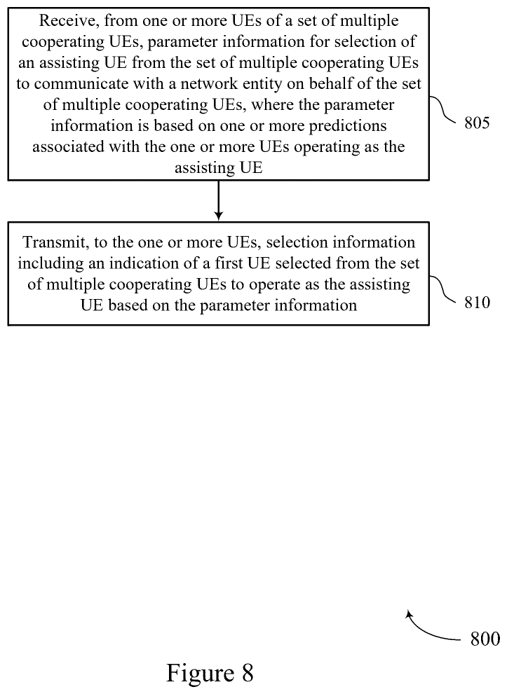

FIG. 8 shows an example of a method 800 that supports selecting an assisting device. Operations of the method 800 may be performed by a UE 115 or a network entity 105 or respective components (such as using a processing system configured to cause the respective device to perform one or more of the operations), as described herein.

At 805, the method may include receiving, from one or more UEs of a set of multiple cooperating UEs, parameter information for selection of an assisting UE from the set of multiple cooperating UEs to communicate with a network entity on behalf of the set of multiple cooperating UEs, where the parameter information is based on one or more predictions associated with the one or more UEs operating as the assisting UE. In some examples, aspects of the operations of 805 may be performed by a parameter information component 425 or a parameter information component 625.

At 810, the method may include transmitting, to the one or more UEs, selection information including an indication of a first UE selected from the set of multiple cooperating UEs to operate as the assisting UE based on the parameter information. In some examples, aspects of the operations of 810 may be performed by a selection information component 430 or a selection information component 630.

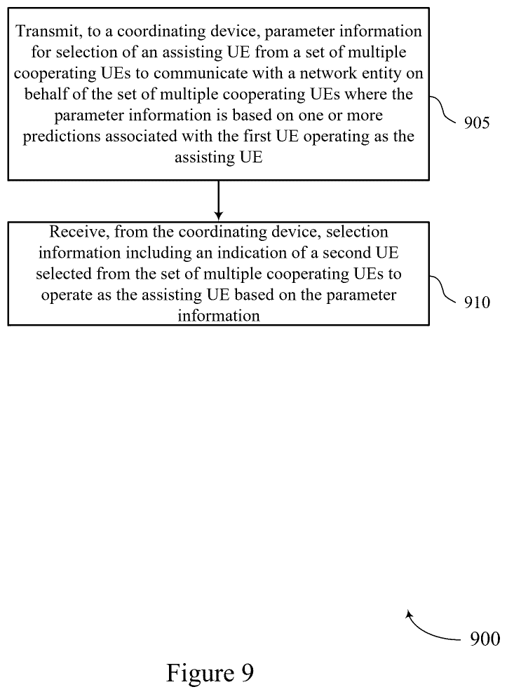

FIG. 9 shows an example of a method 900 that supports selecting an assisting device. Operations of the method 900 may be performed by a UE or its components (such as using a processing system configured to cause the UE 115 to perform one or more of the operations) as described herein.

At 905, the method may include transmitting, to a coordinating device, parameter information for selection of an assisting UE from a set of multiple cooperating UEs to communicate with a network entity on behalf of the set of multiple cooperating UEs where the parameter information is based on one or more predictions associated with the first UE operating as the assisting UE. In some examples, aspects of the operations of 905 may be performed by a parameter information component 425.

At 910, the method may include receiving, from the coordinating device, selection information including an indication of a second UE selected from the set of multiple cooperating UEs to operate as the assisting UE based on the parameter information. In some examples, aspects of the operations of 910 may be performed by a selection information component 430.

Aspect 1: A method for wireless communications at a device, comprising: receiving, from one or more UEs of a plurality of cooperating UEs, parameter information for selection of an assisting UE from the plurality of cooperating UEs to communicate with a network entity on behalf of the plurality of cooperating UEs, wherein the parameter information is based at least in part on one or more predictions associated with the one or more UEs operating as the assisting UE; and transmitting, to the one or more UEs, selection information comprising an indication of a first UE selected from the plurality of cooperating UEs to operate as the assisting UE based at least in part on the parameter information.

Aspect 2: The method of aspect 1, further comprising: determining, for each of the plurality of cooperating UEs, a metric based on respective parameter information of the plurality of cooperating UEs; and selecting the first UE from the plurality of cooperating UEs to operate as the assisting UE based at least in part on a first metric for the first UE having a highest value among the plurality of cooperating UEs.

Aspect 3: The method of aspect 2, wherein the metric for the first UE is based at least in part on a linear combination of a plurality of parameters of the first UE.

Aspect 4: The method of any of aspects 1 through 3, further comprising: receiving, from the network entity, configuration information for the selection of the assisting UE, wherein the configuration information comprises a mapping function between the parameter information and a metric that is representative of the parameter information.

Aspect 5: The method of any of aspects 1 through 4, further comprising: receiving, from the network entity, configuration information for the selection of the assisting UE, wherein the configuration information comprises an indication of the one or more predictions, prediction window information, threshold information, a quantity of samples associated with the prediction window information, or any combination thereof.

Aspect 6: The method of any of aspects 1 through 5, further comprising: transmitting, to the one or more UEs, configuration information for determination of the parameter information, wherein the configuration information identifies the one or more predictions.

Aspect 7: The method of aspect 6, wherein the configuration information includes a duration associated with the one or more predictions, one or more thresholds associated with the one or more predictions, a quantity of prediction determinations associated with the duration, or any combination thereof.

Aspect 8: The method of any of aspects 1 through 7, wherein the one or more predictions comprises a link quality prediction, a traffic prediction, a mobility prediction, a battery consumption prediction, or any combination thereof.

Aspect 9: The method of any of aspects 1 through 8, further comprising: selecting the first UE from the plurality of cooperating UEs based at least in part on UE behavior information indicated by the parameter information.

Aspect 10: The method of any of aspects 1 through 9, further comprising: selecting the device from the plurality of cooperating UEs as the assisting UE; and communicating, as the assisting UE, information with the network entity on behalf of the plurality of cooperating UEs.

Aspect 11: The method of any of aspects 1 through 10, wherein the selection information comprises a duration associated with operation of the first UE as the assisting UE.

Aspect 12: The method of any of aspects 1 through 11, wherein the parameter information comprises area information associated with operation as the assisting UE.

Aspect 13: The method of any of aspects 1 through 12, further comprising: transmitting, to the first UE, a request for a status of the first UE as the assisting UE; and receiving, from the first UE, status information associated with the first UE operating as the assisting UE.

Aspect 14: A method for wireless communications at a first UE, comprising: transmitting, to a coordinating device, parameter information for selection of an assisting UE from a plurality of cooperating UEs to communicate with a network entity on behalf of the plurality of cooperating UEs wherein the parameter information is based at least in part on one or more predictions associated with the first UE operating as the assisting UE; and receiving, from the coordinating device, selection information comprising an indication of a second UE selected from the plurality of cooperating UEs to operate as the assisting UE based at least in part on the parameter information.

Aspect 15: The method of aspect 14, further comprising: determining, for the first UE, a metric based at least in part on a linear combination of a plurality of parameters comprising at least the one or more predictions, wherein the parameter information comprises the metric.

Aspect 16: The method of any of aspects 14 through 15, further comprising: receiving, from a network entity, configuration information for the selection of the assisting UE, wherein the configuration information comprises an indication of the one or more predictions, prediction window information, threshold information, a quantity of samples associated with the prediction window information, or any combination thereof.

Aspect 17: The method of any of aspects 14 through 16, further comprising: receiving, from the coordinating device, configuration information for determination of the parameter information, wherein the configuration information identifies the one or more predictions.

Aspect 18: The method of aspect 17, wherein the configuration information includes a duration associated with the one or more predictions, one or more thresholds associated with the one or more predictions, a quantity of prediction determinations associated with the duration, or any combination thereof.

Aspect 19: The method of any of aspects 14 through 18, wherein the one or more predictions comprises a link quality prediction, a traffic prediction, a mobility prediction, a battery consumption prediction, or any combination thereof.

Aspect 20: The method of any of aspects 14 through 19, wherein the selection information comprises a duration associated with operation of the second UE as the assisting UE.

Aspect 21: The method of any of aspects 14 through 20, wherein the parameter information comprises area information associated with the first UE operating as the assisting UE.

Aspect 22: The method of any of aspects 14 through 21, wherein the parameter information comprises UE behavior information associated with the first UE.

Aspect 23: The method of any of aspects 14 through 22, further comprising: communicating, via the assisting UE, information with a network entity.

Aspect 24: The method of any of aspects 14 through 23, further comprising: communicating, as the assisting UE, information with the network entity on behalf of the plurality of cooperating UEs, wherein the selection information identifies the first UE as the assisting UE, and wherein the first UE and the second UE are the same.

Aspect 25: A device for wireless communications, comprising a processing system that includes processor circuitry and memory circuitry that stores code, the processing system configured to cause the device to perform a method of any of aspects 1 through 13.

Aspect 26: A device for wireless communications, comprising at least one means for performing a method of any of aspects 1 through 13.

Aspect 27: A non-transitory computer-readable medium storing code for wireless communications, the code comprising instructions executable by one or more processors to perform a method of any of aspects 1 through 13.

Aspect 28: A first UE for wireless communications, comprising a processing system that includes processor circuitry and memory circuitry that stores code, the processing system configured to cause the first UE to perform a method of any of aspects 14 through 24.

Aspect 29: A first UE for wireless communications, comprising at least one means for performing a method of any of aspects 14 through 24.

Aspect 30: A non-transitory computer-readable medium storing code for wireless communications, the code comprising instructions executable by one or more processors to perform a method of any of aspects 14 through 24.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A device, comprising:
a processing system that includes processor circuitry and memory circuitry that stores code, the processing system configured to cause the device to:
receive, from one or more UEs of a plurality of cooperating UEs, parameter information for selection of an assisting UE from the plurality of cooperating UEs to communicate with a network entity on behalf of the plurality of cooperating UEs, wherein the parameter information is based at least in part on one or more predictions associated with the one or more UEs operating as the assisting UE; and
transmit, to the one or more UEs, selection information comprising an indication of a first UE selected from the plurality of cooperating UEs to operate as the assisting UE based at least in part on the parameter information.

2. The device of claim 1, wherein the processing system is further configured to cause the device to:
determine, for each of the plurality of cooperating UEs, a metric based on respective parameter information of the plurality of cooperating UEs; and
select the first UE from the plurality of cooperating UEs to operate as the assisting UE based at least in part on a first metric for the first UE having a highest value among the plurality of cooperating UEs.

3. The device of claim 2, wherein the metric for the first UE is based at least in part on a linear combination of a plurality of parameters of the first UE.

4. The device of claim 1, wherein the processing system is further configured to cause the device to:
receive, from the network entity, configuration information for the selection of the assisting UE, wherein the configuration information comprises a mapping function between the parameter information and a metric that is representative of the parameter information.

5. The device of claim 1, wherein the processing system is further configured to cause the device to:
receive, from the network entity, configuration information for the selection of the assisting UE, wherein the configuration information comprises an indication of the one or more predictions, prediction window information, threshold information, a quantity of samples associated with the prediction window information, or any combination thereof.

6. The device of claim 1, wherein the processing system is further configured to cause the device to:
transmit, to the one or more UEs, configuration information for determination of the parameter information, wherein the configuration information identifies the one or more predictions.

7. The device of claim 6, wherein the configuration information includes a duration associated with the one or more predictions, one or more thresholds associated with the one or more predictions, a quantity of prediction determinations associated with the duration, or any combination thereof.

8. The device of claim 1, wherein the one or more predictions comprises a link quality prediction, a traffic prediction, a mobility prediction, a battery consumption prediction, or any combination thereof.

9. The device of claim 1, wherein the processing system is further configured to cause the device to:
select the first UE from the plurality of cooperating UEs based at least in part on UE behavior information indicated by the parameter information.

10. The device of claim 1, wherein the processing system is further configured to cause the device to:
select the device from the plurality of cooperating UEs as the assisting UE; and
communicate, as the assisting UE, information with the network entity on behalf of the plurality of cooperating UEs.

11. The device of claim 1, wherein the selection information comprises a duration associated with operation of the first UE as the assisting UE.

12. The device of claim 1, wherein the parameter information comprises area information associated with operation as the assisting UE.

13. The device of claim 1, wherein the processing system is further configured to cause the device to:
transmit, to the first UE, a request for a status of the first UE as the assisting UE; and
receive, from the first UE, status information associated with the first UE operating as the assisting UE.

14. A first user equipment (UE), comprising:
a processing system that includes processor circuitry and memory circuitry that stores code, the processing system configured to cause the first UE to:
transmit, to a coordinating device, parameter information for selection of an assisting UE from a plurality of cooperating UEs to communicate with a network entity on behalf of the plurality of cooperating UEs wherein the parameter information is based at least in part on one or more predictions associated with the first UE operating as the assisting UE; and
receive, from the coordinating device, selection information comprising an indication of a second UE selected from the plurality of cooperating UEs to operate as the assisting UE based at least in part on the parameter information.

15. The first UE of claim 14, wherein the processing system is further configured to cause the first UE to:
determine, for the first UE, a metric based at least in part on a linear combination of a plurality of parameters comprising at least the one or more predictions, wherein the parameter information comprises the metric.

16. The first UE of claim 14, wherein the processing system is further configured to cause the first UE to:
receive, from a network entity, configuration information for the selection of the assisting UE, wherein the configuration information comprises an indication of the one or more predictions, prediction window information, threshold information, a quantity of samples associated with the prediction window information, or any combination thereof.

17. The first UE of claim 14, wherein the processing system is further configured to cause the first UE to:
receive, from the coordinating device, configuration information for determination of the parameter information, wherein the configuration information identifies the one or more predictions.

18. The first UE of claim 17, wherein the configuration information includes a duration associated with the one or more predictions, one or more thresholds associated with the one or more predictions, a quantity of prediction determinations associated with the duration, or any combination thereof.

19. The first UE of claim 14, wherein the one or more predictions comprises a link quality prediction, a traffic prediction, a mobility prediction, a battery consumption prediction, or any combination thereof.

20. The first UE of claim 14, wherein the selection information comprises a duration associated with operation of the second UE as the assisting UE.

21. The first UE of claim 14, wherein the parameter information comprises area information associated with the first UE operating as the assisting UE.

22. The first UE of claim 14, wherein the parameter information comprises UE behavior information associated with the first UE.

23. The first UE of claim 14, wherein the processing system is further configured to cause the first UE to:
communicate, via the assisting UE, information with a network entity.

24. The first UE of claim 14, wherein the processing system is further configured to cause the first UE to:
communicate, as the assisting UE, information with the network entity on behalf of the plurality of cooperating UEs, wherein the selection information identifies the first UE as the assisting UE, and wherein the first UE and the second UE are the same.

25. A method for wireless communications at a device, comprising:
receiving, from one or more UEs of a plurality of cooperating UEs, parameter information for selection of an assisting UE from the plurality of cooperating UEs to communicate with a network entity on behalf of the plurality of cooperating UEs, wherein the parameter information is based at least in part on one or more predictions associated with the one or more UEs operating as the assisting UE; and
transmitting, to the one or more UEs, selection information comprising an indication of a first UE selected from the plurality of cooperating UEs to operate as the assisting UE based at least in part on the parameter information.

26. The method of claim 25, further comprising:
determining, for each of the plurality of cooperating UEs, a metric based on respective parameter information of the plurality of cooperating UEs; and
selecting the first UE from the plurality of cooperating UEs to operate as the assisting UE based at least in part on a first metric for the first UE having a highest value among the plurality of cooperating UEs.

27. The method of claim 25, further comprising:
receiving, from the network entity, configuration information for the selection of the assisting UE, wherein the configuration information comprises a mapping function between the parameter information and a metric that is representative of the parameter information.

28. The method of claim 25, further comprising:
receiving, from the network entity, configuration information for the selection of the assisting UE, wherein the configuration information comprises an indication of the one or more predictions, prediction window information, threshold information, a quantity of samples associated with the prediction window information, or any combination thereof.

29. A method for wireless communications at a first user equipment (UE), comprising:
transmitting, to a coordinating device, parameter information for selection of an assisting UE from a plurality of cooperating UEs to communicate with a network entity on behalf of the plurality of cooperating UEs wherein the parameter information is based at least in part on one or more predictions associated with the first UE operating as the assisting UE; and
receiving, from the coordinating device, selection information comprising an indication of a second UE selected from the plurality of cooperating UEs to operate as the assisting UE based at least in part on the parameter information.

30. The method of claim 29, further comprising:
determining, for the first UE, a metric based at least in part on a linear combination of a plurality of parameters comprising at least the one or more predictions, wherein the parameter information comprises the metric.
